(19) United States
(12) Patent Application Publication
(10) Pub. No.: US 2015/0224858 A1
(43) Pub. Date: Aug. 13, 2015

(54) AUTOMOBILE DOOR STRUCTURE

(71) Applicant: TOYOTA JIDOSHA KABUSHIKI KAISHA, Toyota-shi (JP)

(72) Inventor: Keiichirou YOSHIMOTO, Kariya-shi (JP)

(21) Appl. No.: 14/601,576

(22) Filed: Jan. 21, 2015

(30) Foreign Application Priority Data
Feb. 12, 2014 (JP) 2014-024373

(51) Int. Cl. B60J 5/04

(52) U.S. Cl. CPC B60J 5/0458

(57) ABSTRACT

A block is located to cover an end portion of a handle frame and a site on a rear surface of an outer panel adjacent to the end portion of the handle frame. When the front surface of the outer panel deforms to dent, the block regulates deformation of the site of the outer panel covered with the block.

### BACKGROUND OF THE INVENTION

The present invention relates to an automobile door structure.

Some door structures for preventing outer panels from deforming due to side collision to cause doors to open are proposed.

In Japanese Laid-Open Patent Publication No. 2007-53918, a handle frame is fixed on an internal surface of an outer panel. On the handle frame, a door handle is swingably supported. In a gap between the handle frame and a structure arranged near an inner panel, a filling material is located. At the time of side collision, the filling material collides with the structure in the inner panel to regulate movement of the handle frame to the inner panel. In this manner, the door handle cannot be expanded with respect to the handle frame, and the door handle is prevented from being pulled to the outside.

A door lock device disclosed in Japanese Laid-Open Patent Publication No. 2000-142115 includes a sash that guides vertical movement of a plate glass of a door and a transmission mechanism that transmits a lock-releasing operation of a door handle to a locking mechanism. A protector is formed on the sash to prevent an outer panel from abutting against a desired site of the transmission mechanism even though the outer panel deforms toward the inside due to side collision.

In Japanese Laid-Open Patent Publication No. 2002-240563, an outer reinforce is attached to an upper rear surface of an outer panel. Further, a protector is formed on a terminal portion of the outer reinforce. The protector is located between a sash that guides vertical movement of a plate glass of a door and a mechanical part of a door handle. In the protector, a stopper that can engage with a movable portion of the mechanical part of the door handle is formed. When the movable portion of the door handle turns, the stopper and the movable portion engage with each other. In this manner, since an operation of the door handle in a lock-releasing direction is suppressed, the door handle is protected to prevent the door handle from interfering with the sash due to external impact.

FIG. 10 shows a door 100 of an automobile. As shown in FIG. 11, when the door 100 is to be opened from the outside of the automobile, a door handle 104 attached to an outer panel 102 is pulled to bring the door 100 in an openable state. That is, the door handle 104 is operated as described above to release the locking of the door 100 and a body. When the door 100 is closed, a latch of a locking mechanism (not shown) of the door handle 104 is engaged with a striker. The door handle 104 is swingably supported on a handle frame (not shown) fixed on a rear surface of the outer panel 102. Symbols o in FIG. 11 and FIG. 12 show a swinging center of the door handle 104.

FIG. 12 shows a status in which an external object 110 collides with the outer panel 102 from the side. In this case, the outer panel 102 dents inside around the door handle 104. Further, when this deformation spreads to the vicinity of a base of the door handle 104, that is, a site S on an outer front surface of the outer panel 102, the base of the door handle 104 is depressed by the portion S of the outer panel 102. In this manner, as indicated by an arrow P in FIG. 12, the door handle 104 is brought in an openable state in which the door handle 104 is pulled to the outside with respect to the door 100. As a result, the locking of the door 100 and the body tends to be released.

However, the above-described patent documents neither disclose nor suggest a response to the case in which the base of the door handle 104 is depressed by the deformed outer panel 102 to release the locking of the door and the body.

### SUMMARY OF THE INVENTION

It is an object of the present invention to provide an automobile door structure that can restrain a door handle from being brought in an openable state due to deformation of an outer panel.

In order to solve the problem, according to a first aspect of the present invention, there is provided an automobile door structure including a door handle located on a front surface of an outer panel, and a handle frame located on a rear surface of the outer panel and having an end portion swingably supporting the door handle. The automobile door structure includes a block configured to cover the end portion of the handle frame and a site on the rear surface of the outer panel adjacent to the end portion of the handle frame. When the outer panel deforms to dent, the block regulates deformation of the site of the outer panel covered with the block.

### BRIEF DESCRIPTION OF THE DRAWINGS

FIG. 1 is a plan cross-sectional view of an automobile door structure according to a first embodiment of the present invention;

FIG. 2 is an exploded perspective view of the door structure;

FIG. 3 is a perspective view of a block configuring the door structure;

FIG. 4 is a perspective view of a fastening member configuring the door structure;

FIG. 5 is a sectional view along a 5-5 line in FIG. 2;

FIG. 6 is an exploded perspective view of a door structure according to a second embodiment of the present invention;

FIG. 7 is a sectional view along a 7-7 line in FIG. 6;

FIG. 8 is an exploded perspective view of a door structure according to a third embodiment of the present invention;

FIG. 9 is a longitudinal sectional view showing a state in which a block configuring the door structure is assembled in a handle frame;

FIG. 10 a schematic view of a door of an automobile;

FIG. 11 is a sectional view showing a door structure of the related art; and

FIG. 12 is a sectional view showing an action of the door structure of the related art.

### DETAILED DESCRIPTION OF THE PREFERRED EMBODIMENTS

### First Embodiment

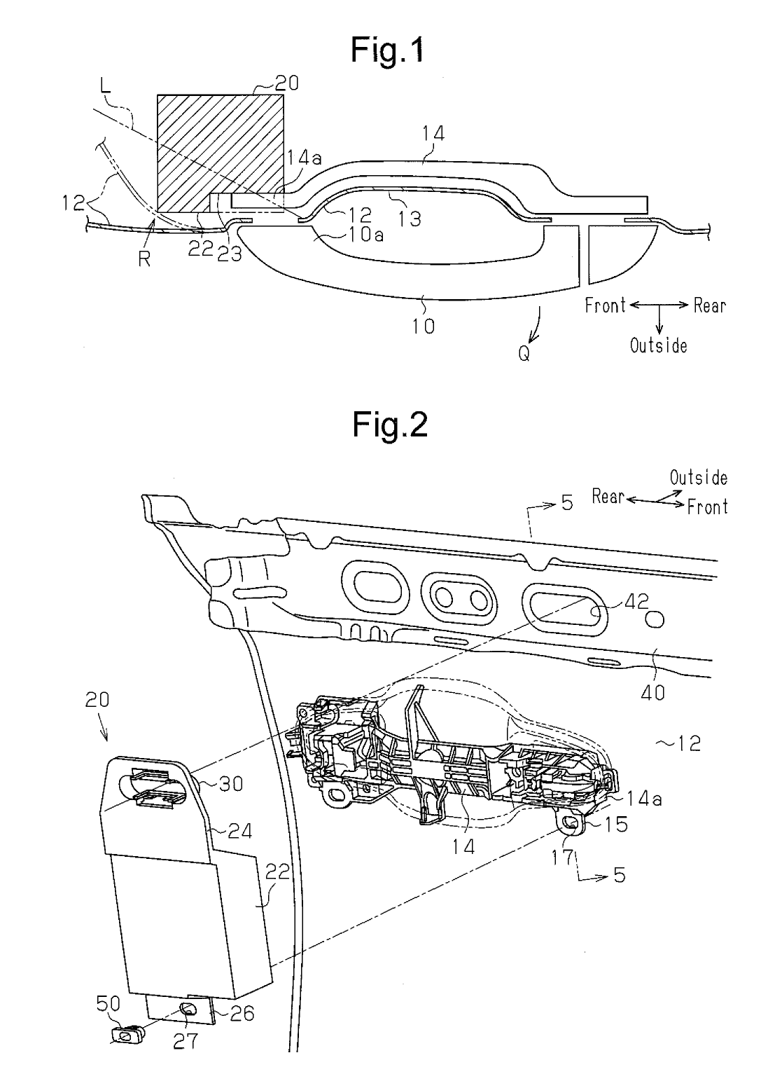

A first embodiment in which an automobile door structure according to the present invention is applied to a side door will be described below with reference to FIG. 1 to FIG. 5.

As shown in FIG. 1, a door handle 10 is located on a front surface on the outside of an outer panel 12 configuring the side door. A handle frame 14 is fixed on an internal surface of the outer panel 12. The door handle 10 is swingably supported on an end portion 14a in the longitudinal direction of the handle frame 14. The longitudinal direction of the handle frame 14 is the same as the front-rear direction of a vehicle.

FIG. 2 is a perspective view of the outer panel 12 when viewed from a rear surface thereof. On the front surface of the outer panel 12, a concave portion 13 for grasping the door handle 10 is formed. A chain double-dashed line in FIG. 2 indicates a site where the rear surface of the outer panel 12 projects due to the concave portion 13. Also in another embodiment, the above-described chain double-dashed line indicates the site where the rear surface of the outer panel 12 projects due to the concave portion 13.

The door handle 10 is operated to swing in the direction of an arrow Q from a non-operating state shown in FIG. 1. Then, in conjunction with the operation of the door handle 10, the locking of a latch of a mechanical part (not shown) attached to the side door and a striker (not shown) attached to a body is released. On the other hand, when the door handle 10 is operated to swing in a direction opposite to the direction of the arrow Q from an openable state in which the locking is released, the latch engages with the striker to set the locking.

As shown in FIG. 1, the end portion 14a of the handle frame 14 is close to a base 10a of the door handle 10. From a lower portion of the end portion 14a, a support piece 15 having a fitting hole 17 extends downward. Inside the outer panel 12, a block 20 is located. The block 20 covers the end portion 14a of the handle frame 14 and a site of the outer panel 12 located ahead of the end portion 14a. The block 20 is made of a synthetic resin. The material of the block 20 is not limited to a synthetic resin as long as the material has rigidity.

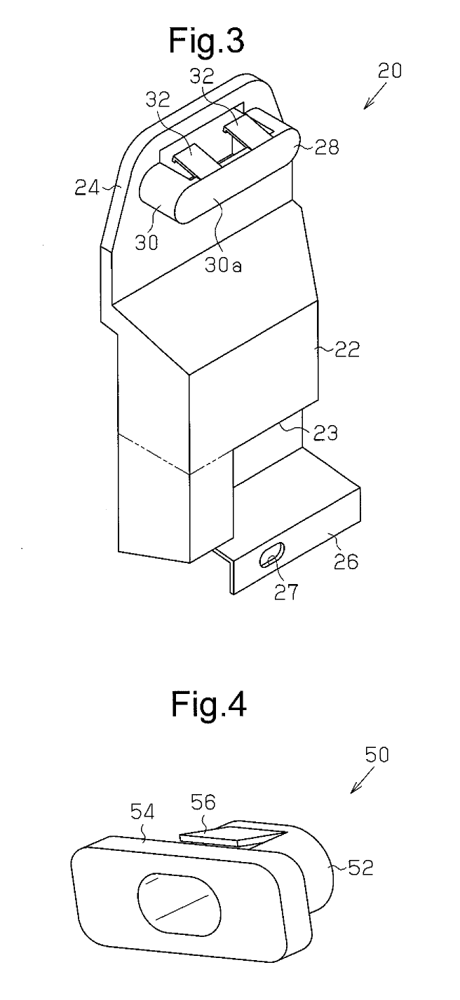

As shown in FIG. 2 and FIG. 3, the block 20 has a block portion 22 and attachment pieces 24 and 26. The block portion 22 forms a central portion in the vertical direction of the block 20.

The attachment piece 24 forms an upper portion of the block 20, and the attachment piece 26 forms a lower portion of the block 20. A notch 23 for storing the end portion 14a of the handle frame 14 is formed in the lower portion of the block portion 22. In this manner, a surface facing the outer panel 12 of the block portion 22 has an L shape.

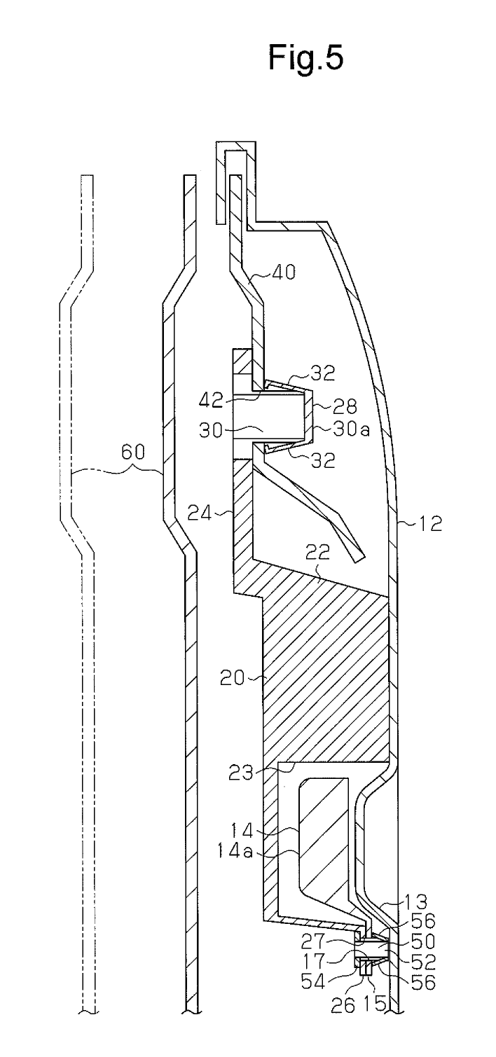

As shown in FIG. 2, FIG. 3, and FIG. 5, a clip portion 28 is formed on the attachment piece 24. The clip portion 28 projects from the attachment piece 24 toward the outer panel 12. The clip portion 28 is an example of a clip section. The clip portion 28 has an engagement projection 30 projecting from the attachment piece 24 and a plurality of claw pieces 32. The engagement projection 30 is formed in a lidded cylindrical shape. The plurality of claw pieces 32 projects from upper and lower sides of the engagement projection 30. Each of the claw pieces 32 spread outward from a lid 30a of the engagement projection 30 to the left in FIG. 5. For this reason, the claw pieces 32 have proper elasticity and are formed to be deformable inward. On an upper portion of the rear surface of the outer panel 12, an outer reinforce 40 having a fitting hole 42 is fixed. When the clip portion 28 is fitted into the fitting hole 42 against the elastic force of the claw pieces 32, the claw pieces 32 are latched on a peripheral edge of the fitting hole 42 of the outer reinforce 40.

The attachment piece 26 has a through hole 27 in a site that comes in surface contact with the support piece 15 of the handle frame 14. The through hole 27 is formed at a position facing the fitting hole 17 of the support piece 15. The attachment piece 26 is attached to the support piece 15 by using a clip 50 while being in surface contact with the support piece 15. The clip 50 is an example of the clip section.

As shown in FIG. 4, the clip 50 has an engagement portion 52, a flange 54, and a pair of claw pieces 56. The engagement portion 52 is formed in a cylindrical shape. The flange 54 is formed at a base end of the engagement portion 52. The pair of claw pieces 56 project from the upper and lower sides of the engagement projection 52, respectively. Each of the claw pieces 56 spreads outward from a leading end of the engagement portion 52 toward the left in FIG. 4. The claw pieces 56 have proper elasticity and are formed to be deformable inward. As shown in FIG. 5, when the clip 50 is fitted into the fitting hole 17 of the support piece 15 against the elastic force of the claw pieces 56, the claw pieces 56 are latched on the peripheral edge of the fitting hole 17 of the support piece 15. A chain double-dashed line in FIG. 5 indicates a position of an inner panel 60 at normal time. A solid line in FIG. 5 indicates a position of the inner panel 60 having moved when the side door is impacted by an external object.

When the side door is impacted by the external object, the outer panel 12, the handle frame 14 fixed on the outer panel 12, and the block 20 move toward the inner panel 60. For descriptive convenience, the illustration is made in FIG. 5 on the assumption that the inner panel 60 moves with respect to the outer panel 12, the handle frame 14, and the block 20. Moreover, the following action will be described on the assumption that the inner panel 60 moves with respect to the outer panel 12, the handle frame 14, and the block 20.

An action of the above-described automobile door structure will be described below with reference to FIG. 1 and FIG. 5.

A case in which an external object collides with the side door from the side ahead of the door handle 10 will be described. In this case, as shown in FIG. 5, the inner panel 60 configuring the side door also moves with respect to the outer panel 12. For this reason, a gap between the inner panel 60 and the outer panel 12, and a gap between the inner panel 60 and the block 20 decrease. At this time, as shown in FIG. 1, the block 20 functions as a spacer. For this reason, a deformation point of the outer panel 12 is determined at a corner portion R located ahead of the end portion 14a of the block portion 22. Based on the deformation point, the outer panel 12 deforms to dent inward. Specifically, the outer panel 12 deforms from a shape indicated by a solid line to a shape indicated by a chain double-dashed line in FIG. 1. As a result, the base 10a of the door handle 10 is not influenced by the deformation of the outer panel 12. Thus, the door handle 10 is not brought in an openable state in which the door handle 10 is pulled to the outside with respect to a door.

In an example of the related art that does not include the block 20, for example, the outer panel 12 tends to be bent along an L line in FIG. 1. As shown in FIG. 1, the L line passes near the base 10a of the door handle 10. In this case, the door handle 10 is easily brought in the openable state in which the door handle 10 is pulled to the outside with respect to the door, and the locking of the side door and the body tends to be released.

Thus, according to the first embodiment, the following effects can be obtained.

(1) The block 20 covers the end portion 14a of the handle frame 14 and the site on the rear surface of the outer panel 12 adjacent to the end portion 14a of the handle frame 14. According to this configuration, when the outer panel 12 deforms to dent, deformation of the site of the outer panel 12 covered with the block 20 can be regulated. For this reason, the door handle 10 can be restrained from being brought in an openable state due to the deformation of the outer panel 12.

As described above, in Japanese Laid-Open Patent Publication No. 2007-63918, the filling material is located in the gap between the handle frame and the structure arranged near the inner panel. According to this configuration, the filling material collides with the structure to regulate movement of the handle frame to the inner panel. In this case, since it is essential to install a structure such as a division bar that collides with the filling material at the time of the deformation of the outer panel, the position of the filling material is restricted according to the installation position of the structure. In contrast to this, the first embodiment is advantageous over the technique of the related art in that the position of the block is irrelevant to the installation position of the structure located near the inner panel.

(2) The block 20 is attached to the handle frame 14 and the outer reinforce 40 fixed on the rear surface of the outer panel 12. According to this configuration, the handle frame 14 and the block 20 can easily achieve the above-described effect (1).

(3) The block 20 is attached to the handle frame 14 by using the clip 50 and attached to the outer reinforce 40 by using the clip portion 28. According to this configuration, it is not necessary to form the block 20 in the handle frame 14 in advance. That is, the block 20 can be attached to the handle frame 14 later.

### Second Embodiment

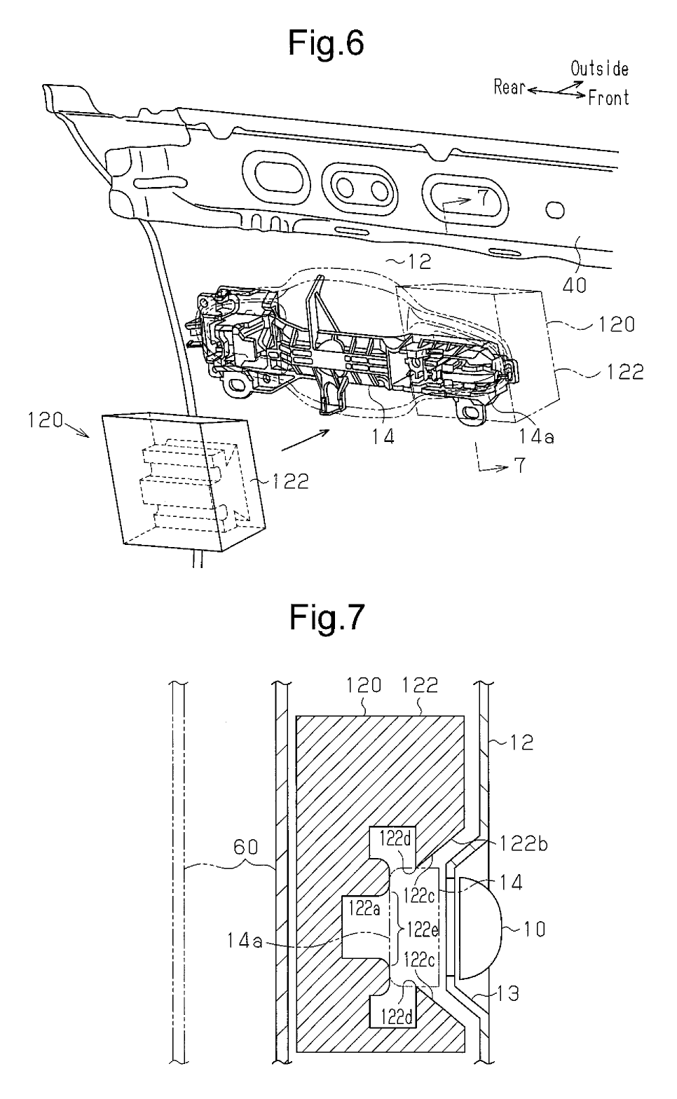

Next, a second embodiment embodying an automobile door structure according to the present invention will be described below with reference to FIG. 6 and FIG. 7. The same portions in the second embodiment as those in the first embodiment will not be described in detail.

A block 120 in the second embodiment is different from the block 20 in the first embodiment in that attachment pieces 24 and 26 and a notch 23 are omitted and in an attachment structure of the block 120.

As shown in FIG. 6 and FIG. 7, the block 120 includes a block portion 122 of a nearly rectangular parallelepiped or a nearly regular hexahedron, and is made of a synthetic resin. The block portion 122 shown in FIG. 6 is of a nearly rectangular parallelepiped. A fitting concave portion 122a is formed on a surface facing an outer panel 12 of the block portion 122.

As shown in FIG. 7, an end portion 14a of a handle frame 14 is fitted to the fitting concave portion 122a of the block 120 to attach the block 120 to the handle frame 14. In the fitting concave portion 122a, an opening 122b for guiding the end portion 14a of the handle frame 14 fitted to the fitting concave portion 122a to an inner part. The opening 122b is formed by an upper surface and a lower surface. Both the upper surface and the lower surface are inclined guide surfaces 122c. The upper surface and the lower surface are each arranged such that an interval between the upper surface and the lower surface is narrowed toward the inner part in the fitting concave portion 122a. As shown in FIG. 7, leading ends located at trailing ends of both the guide surfaces 122c are meshing portions 122d, and are each in a shape of a peaked edge. Since the meshing portions 122d have elasticity, the meshing portions 122d elastically hold the end portion 14a of the handle frame 14 fitted to the fitting concave portion 122a.

A pair of stoppers 122e is formed in the inner parts of the meshing portions 122d in the fitting concave portion 122a. The pair of stoppers 122e are caused to abut against the end portion 14a of the handle frame 14 pressed into the inner parts of the meshing portions 122d. As in the first embodiment, the block 120 is also located to cover the end portion 14a of the handle frame 14 and a site of the outer panel 12 located ahead of the end portion 14a. For this reason, an action in the case where an external object collides with a side door from the side ahead of a door handle 10 is the same as that in the first embodiment. On the other hand, the attachment structure of the block 120 is different from that in the first embodiment. The attachment pieces 24 and 26, an engagement projection 30, and the like are unnecessary, and a separate member such as a clip 50 is also unnecessary. Thus, since the number of parts, the number of assembling steps, and the like are reduced, the block 120 can be easily assembled.

Thus, according to the second embodiment, the following effects can be obtained.

(4) Since the block 120 can be fitted to the handle frame 14, a member for assembling the block 120 is unnecessary, and the number of assembling steps is reduced.

### Third Embodiment

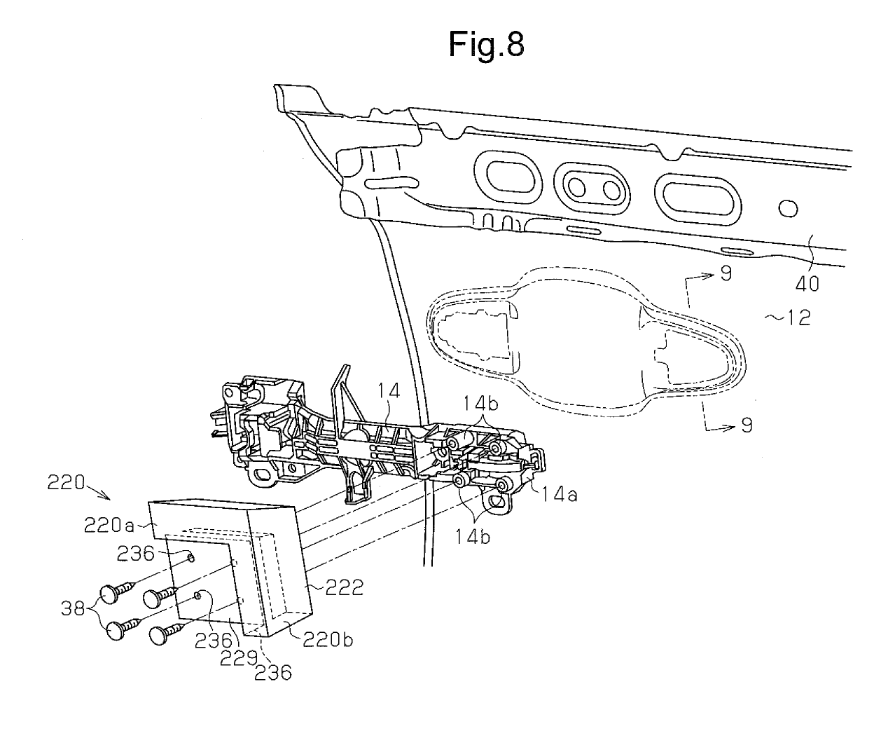

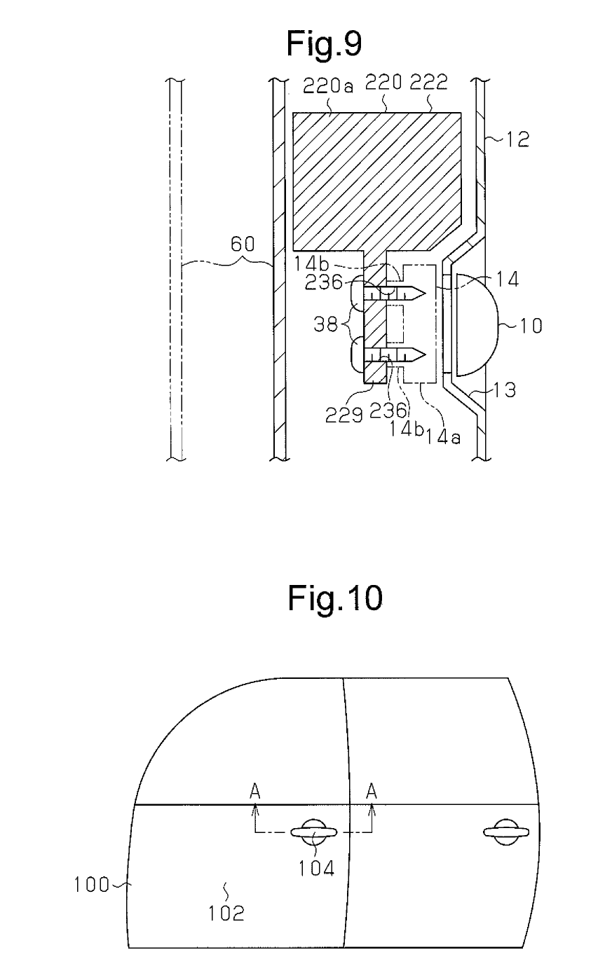

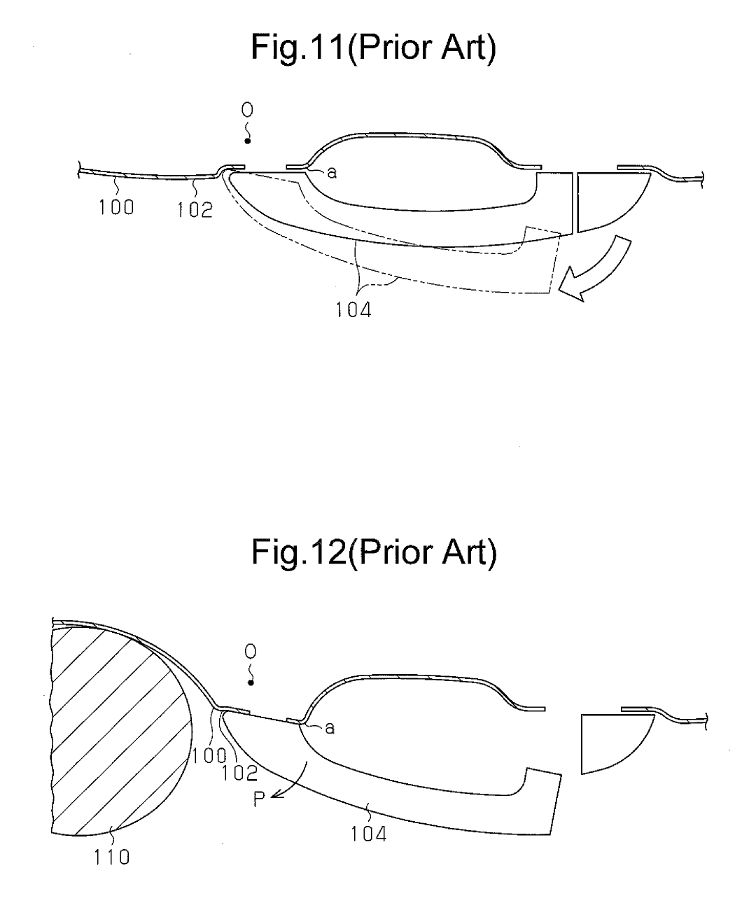

Next, a third embodiment embodying an automobile door structure according to the present invention will be described below with reference to FIG. 8 and FIG. 9. The same portions in the third embodiment as those in the first embodiment will not be described in detail.

A block 220 in the third embodiment is different from the block 20 according to the first embodiment in that attachment pieces 24 and 26 and a notch 23 are omitted and in an attachment structure of the block 220.

As shown in FIG. 8, the block 220 includes an inverted-L-shaped block portion 222 including a site 220a extending in the front-rear direction and a site 220b extending in the vertical direction. An attachment plate 229 is formed between the sites 220a and 220b. In the attachment plate 229, a plurality of through holes 236 is formed. The material of the block 220 may be metal or a synthetic resin.

At an end portion 14a of a handle frame 14, a plurality of female screws 14b is formed. Screws 38 serving as fastening members pass through the through holes 236 of the attachment plate 229 and are threadly engaged with the female screws 14b of the handle frame 14. For this reason, the block 220 is attached to the handle frame 14. As in the first embodiment, the block 220 is also located to cover the end portion 14a of the handle frame 14 and a site of an outer panel 12 located ahead of the end portion 14a. For this reason, an action in the case where an external object collides with a side door from the side ahead of a door handle 10 is the same as that in the first embodiment.

Thus, according to the third embodiment, the following effects can be obtained.

(5) The block 220 is attached to and fixed on the handle frame 14 by using the screws 38. As a result, it is not necessary to form the block 220 in the handle frame 14 in advance. That is, the block 220 can be attached to the handle frame 14 later.

The above-described embodiments may be changed as described below.

In the first embodiment, the clip portion 28 and the clip 50 are embodied as the clip section. However, in place of the clip portion 28, a clip separate from the block 20 may be used. In this case, the attachment piece 24 of the block 20 is attached to the outer reinforce 40 by using another clip. Moreover, another clip portion having the same claw pieces as those of the clip portion 28 may be formed at a position different from that of the clip portion 28 of the block 20. In this case, the attachment piece 26 of the block 20 is attached to the fitting hole 17 of the support piece 15 of the handle frame 14 by using another clip portion.

In the first embodiment, the block 20 is attached to both the handle frame 14 and the outer reinforce 40 fixed on the rear surface of the outer panel 12. However, the block 20 may be attached to any one of the handle frame 14 and the outer reinforce 40.

In the first embodiment, since the notch 23 is formed in the lower portion of the block portion 22, the surface facing the outer panel 12 of the block portion 22 has an L shape as shown in FIG. 3. In place of this, the notch 23 may be omitted in the block portion 22 to form the block portion 22 such that the surface facing the outer panel 12 of the block portion 22 has a square shape, as indicated by a chain double-dashed line in FIG. 3. Moreover, the surface facing the outer panel 12 of the block portion 22 may have a shape other than the square shape.

In the second embodiment, the block portion 22 of the block 120 may have a shape other than a nearly rectangular parallelepiped or a nearly regular hexahedron.

In the second embodiment, a portion fitted to the block 120 may be a site other than the end portion 14a of the handle frame 14, such as a central portion of the handle frame 14.

In the third embodiment, the attachment plate 229 may be omitted in the block 220 to form the entire block 220 in a shape of a regular hexahedron or a rectangular parallelepiped, and to form a through hole in the block 220. In this case, the screws 38 are threadly engaged with the female screws 14b through the through holes in the block 220 to attach the block 220 to the handle frame 14.

In each of the above-described embodiments, the automobile door structure according to the present invention may be employed as a door structure for a rear door. In this case, the door handle can be restrained from being brought in an openable state due to the deformation of the outer panel configuring the rear door.

In each of the above-described embodiments, the block may integrally be formed with the handle frame. In this case, the block and the handle frame may be formed of the same species of metal or the same type of synthetic resin. For example, the handle frame and the block may be formed by casting.

1. An automobile door structure including: a door handle located on a front surface of an outer panel; and a handle frame located on a rear surface of the outer panel and having an end portion swingably supporting the door handle, comprising
a block configured to cover the end portion of the handle frame and a site on the rear surface of the outer panel adjacent to the end portion of the handle frame, wherein
when the outer panel deforms to dent, the block regulates deformation of the site of the outer panel covered with the block.

2. The automobile door structure according to claim 1, wherein
the block is formed to be attached to the handle frame.

3. The automobile door structure according to claim 2, wherein
the block is formed to be attached to the handle frame by a fastening member or a clip section.

4. The automobile door structure according to claim 2, wherein
the block is formed to be fitted to the handle frame.

5. The automobile door structure according to claim 1, wherein
the block is formed to be attached to an outer reinforce fixed on the rear surface of the outer panel.
